(19) United States
(12) Patent Application Publication
(10) Pub. No.: US 2012/0294919 A1
(43) Pub. Date: Nov. 22, 2012

(54) Antimicrobial Silver Silica Composite

(75) Inventors: Bingham Scott Jaynes, New City, NY (US); Matthew Edward Gande, Norwalk, CT (US); Ryan James Fenton, Norwalk, CT (US); Urs Leo Stadler, Madison, NJ (US); Marc Mamak, Mason, OH (US); Sungyeun Choi, Ludwigshafen (DE)

(73) Assignee: BASF SE, Ludwigshafen (DE)

(21) Appl. No.: 13/470,881

(22) Filed: May 14, 2012

Related U.S. Application Data
(60) Provisional application No. 61/486,421, filed on May 16, 2011.

(51) Int. Cl. A01N 25/26; C23C 4/08; A01N 25/08; A01P 1/00; A01N 59/16; A01N 59/20

(52) U.S. Cl. 424/404; 424/421; 424/618; 424/630; 427/455

(57) ABSTRACT

The invention is directed to an antimicrobial metal composite formed by vaporizing an antimicrobial metal or antimicrobial metal salt such as silver, copper or salts thereof using an plasma system and cooling the formed vapor in the presence of a fluidized gas of filler powder. Alternatively, the filler or a filler precursor is entrained with the antimicrobial metal or antimicrobial metal precursor and vaporized and then upon cooling the antimicrobial metal vapor and filler vapor condense to form the composite. The composite shows high antimicrobial activity and can be incorporated into or onto polymers, coatings, textiles, paper, gels (for example for wound care), lubricants, adhesives and cosmetics or pharmaceutical, especially medical devices.

### TECHNICAL FIELD

The invention is directed to an antimicrobial metal composite formed by vaporizing an antimicrobial metal or antimicrobial metal salt such as silver, copper or salts thereof using an plasma system, preferably an induction plasma system and cooling the formed vapor in the presence of a fluidized gas of filler powder, especially amorphous silica or zinc oxide. Alternatively, the filler or a filler precursor is entrained with the antimicrobial metal or antimicrobial metal precursor and vaporized and then upon cooling the antimicrobial metal vapor and filler vapor condense to form the composite. The antimicrobial metal is embedded and distributed throughout the filler matrix. The composite shows high antimicrobial activity and can be incorporated into or onto polymers, coatings, textiles, paper, gels (for example for wound care), lubricants, adhesives and cosmetics or pharmaceutical, especially medical devices. The composite is especially compatible with plastics used in the medical device area such as silicone rubber, polyurethane, polystyrene and block polyether polyamide (ie. PEBAX®).

### BACKGROUND OF THE INVENTION

Antimicrobial silver containing silica particles are known in the literature. For example, it is known to form silver doped silica in the form of particles using flame spray pyrolysis (FSP). PCT publication nos. WO2008/017176 and WO2006/084390 describe such a material.

Egger, S et. al, describes in Applied and environmental Microbiology, May 2009, p 2973-2976 a silver-silica composite material (HeiQ AGS-20, Bad Zurzach, Switzerland).

U.S. Pat. No. 6,872,402 and U.S. Pat. No. 6,423,331 describes a silicon dioxide doped with silver but made via an alternate process.

However, there are multiple drawbacks of the materials produced by previously disclosed methods. For example, flame spray pyrolysis is run at up to 2350° C., is limited to liquids and usually an organic solvent which functions as the combustion source. Flame spray pyrolysis conditions are primarily oxidative. As a result, there is a high risk of contamination from the combustion reactants and synthesis of pure metallic particles is only possible under restrictive oxygen flame conditions.

Moreover, because flame pyrolysis is limited to metal chlorides supplied in vapor like form in the flame, a post cleanup is usually necessary to remove the chorine residues.

Silver or silver containing materials are known to interfere with certain catalytic reactions (for example platinum catalyzed crosslinking reactions). Thus it is usually impossible to use such antimicrobial additives in substrates which require catalyzed crosslinking reaction.

Furthermore, there is a need for an antimicrobial material which is compatible with polymeric substrates but allows for high loading of the antimicrobial effective agent (i.e silver, copper etc.) to achieve an effective antimicrobial effect without adversely affecting the mechanical properties of the substrate, especially the mechanical properties of polymeric substrates.

Accordingly, it is an objective of the invention to produce an antimicrobial metal composite which does not interfere with catalytic crosslinking reactions but still works as an effective antimicrobial, can be added to multiple substrates, especially polymers whilst still retaining high antimicrobial effectiveness and does not adversely impact substrate mechanical properties and is made by a process which avoids many of the process problems encountered in prior art processes such flame spray pyrolysis.

The above objectives are accomplished via formation of an antimicrobial metal composite via a plasma process.

Firstly, avoidance of many of the drawbacks of previously disclosed methods for making antimicrobial metal, especially silver or silver salt containing particles may be overcome by using a plasma process. In particular, an induction plasma process is run at temperatures ranging from 7000 to 10000° C., can be run in inert, reducing, corrosive or oxidizing environs and virtually any solid gas or liquid precursor may serve as the starting material. Additionally because the method requires no combustion source such as a solvent and the precursors are not limited to volatile starting materials (chlorine containing precursors), the final powder is of high purity.

The inventive antimicrobial metal composite produced by the plasma process gives a product which does not interfere with crosslinking of polymeric substrates thus allowing the antimicrobial metal composite to be added to substrates which previously could not be considered because of crosslinking interference with the antimicrobial metal.

Furthermore, the inventive antimicrobial metal composite gives a product which may be added at antimicrobial effective amounts but not adversely effect the mechanical properties of the substrate, especially polymeric substrates.

### SUMMARY OF THE INVENTION

Accordingly, the applicants envision a number of embodiments encompassed by the invention:

A distinct antimicrobial metal carrier, especially silica or zinc oxide, composite prepared via a plasma process, especially induction plasma (product by process) is claimed;

Thus, an antimicrobial metal composite, wherein the composite comprises an antimicrobial metal and a filler which composite is prepared comprising the steps of:

A) providing an antimicrobial metal or antimicrobial metal precursor, preferably the antimicrobial metal or antimicrobial metal precursor is silver or copper or complexes or salts thereof, most preferably the antimicrobial metal or antimicrobial metal precursor is silver, silver complexes or salts thereof;

B) entraining said metal or metal precursor in a stream of gas for transport to a plasma torch;

C) creating a plasma in said stream of gas vaporizing the antimicrobial metal or antimicrobial metal precursor;

D) cooling said metal vapor in the presence of a fluidized gas carrying a filler powder, wherein said cooling results in nucleation of the antimicrobial metal vapor onto the filler to form the composite

or

E) alternatively, the filler or a filler precursor is entrained with the antimicrobial metal or antimicrobial metal precursor in step B) vaporized in step C) and upon cooling the antimicrobial metal vapor and filler vapor condense to form the composite,

wherein the filler or filler precursor in steps D) or E) are
preferably silica, silicates, metal oxides, barium sulfate or precursors thereof, most preferably silica, silicates, metal oxides or precursors thereof and especially silica, zinc oxide or precursors thereof;
and

F) collecting the composite.

Additionally the above process is also envisioned as an embodiment of the present specification.

The above process is believed to produce a unique composite which may be described as:

An antimicrobial metal composite comprising antimicrobial metal nanoparticles ranging from 1 to 20 nm dispersed onto a filler, wherein the antimicrobial metal nanoparticles are surface accessible on and within the filler matrix; and the antimicrobial metal ranges from 25 to 65 wt. percent of the composite.

The antimicrobial metal composite may be incorporated into substrates such as silicone rubber which silicone rubber requires a catalyst to properly cure.

Thus the process of forming an antimicrobial silicone rubber composition is an embodiment and comprises the steps of

i.) adding the composite according to the product formed according to the product by process or the antimicrobial composite defined above, to a silicone rubber composition which composition comprises

a polysiloxane,

an optional crosslinker

and a catalyst, preferably a platinum catalyst,

ii.) and curing the composite containing composition of step i.).

Further, other antimicrobial polymeric materials may be formed which are other than silicone rubber or contain a crosslinking catalyst. Thus we claim a process of forming an antimicrobial polymeric material, comprising the steps of

incorporating into or treating a polymer with the composite according to the product by process or the antimicrobial composite described above.

A use is also considered of the antimicrobial metal composite produced by the plasma process or the antimicrobial metal composite described above and its incorporation into or onto materials selected from the group consisting of coatings, textiles, polymers, gels, adhesives, lubricants, paper, pharmaceuticals and cosmetics.

### SHORT DESCRIPTION OF THE FIGURES

FIG. 1 is a simplified diagram showing induction plasma synthesis used in example 1.

FIG. 2 is transmission electron microscope (TEM) micrographs of a typical silver-silica composite according to examples 1.

FIG. 3 is TEM image of example 2 composite (Ag/ZnO) taken in “COMPO” mode to differentiate Ag from ZnO by different shades of gray in the image. Bright dots are Nano-Ag particles deposited on ZnO crystals. XRD revealed ZnO phase is Wurtzite. The Ag silver particle size ranges from a few nm to 100 nm and the ZnO crystals are sub-micron rod-shaped.

### DETAILED DESCRIPTION OF THE INVENTION

Comprising for purposes of the invention is open ended, that is other components may be included. Comprising is synonymous with containing or including.

Filler

Fillers are well known by the art skilled and may be added to polymers and various substrates to achieve some effect such as scratch resistance, flame retardancy etc. Fillers may be organic or inorganic. The fillers are primarily inorganic and may be crystalline or amorphous.

Preferably, the fillers are selected from the group consisting of silica, silicates including alkali/aluminum silicates, carbonates such as magnesium or calcium carbonates or dolomite, glass fibres or glass spheres, asbestos, talc, kaolin, mica, metal oxides or metal hydroxides, carbon black, graphite, carbon fibres or wiskers, ceramic fibres or wiskers, zinc borate, alumina trihydrate, calcium silicate or magnesium silicate, wollastonite, barium sulfate, barium titanate, barium ferrite and precursors thereof,
preferably silica, silicates, metal oxides, barium sulfate and precursors thereof,
most preferably silica, silicates, metal oxides (ie. zinc oxide, titanium oxide) and precursors thereof and especially silica, zinc oxide and precursors thereof.

The filler functions as a carrier for the present antimicrobial metal.

Whenever the filler term “silica” is used in this application, the term means amorphous SiO₂. Accordingly, when the filler is silica it is selected from the group consisting of fumed silica, silica gels, precipitated silica, colloidal silica, pyrogenic silica and mixtures thereof, preferably the silica is fumed, pyrogenic or mixtures thereof.

Whenever, silica is the filler particular preference is given to fumed silica and pyrogenic silica which is prepared from quartz sand vaporized in a 3000° C. electric arc or in a flame reaction from organosilicon compounds, e.g., from silicon tetrachloride, or from methyldichlorosilane, hydrotrichlorosilane, hydromethyldichlorosilane, or other methylchlorosilanes or alkylchlorosilanes, as they are or in admixture with hydrocarbons, or any desired volatilizable or sprayable mixtures of organosilicon compounds, as mentioned, and hydrocarbons, e.g., in an oxyhydrogen flame, or else in a carbon monoxide/oxygen flame. The silica can be prepared with or without the optional further addition of water, in the purification step, for example. It is preferred not to add water.

The silica morphology is best described as comprising a primary particle having an average primary particle size of less than 100 nm, preferably having an average primary particle size of from 5 to 50 nm, most preferably of less than 20 nm. These primary particles generally do not existing in isolation in the silica but instead are constituents of large aggregates (as defined in DIN 53206) which have a diameter of from 100 to 1000 nm and make up agglomerates (as defined in DIN 53206) which depending on the external shearing load have sizes of greater than 1 micron. The silica has a specific surface area of from 10 to 300 m²/g (measured by the BET method to DIN 66131 and 66132). This is the morphology before undergoing plasma treatment and interaction with the antimicrobial metal.

Composite

A composite for purposes of the invention means a particulate product comprising a filler carrier upon which the antimicrobial metal particles are attached. This is not in any sense a mixture but a discrete particle comprising antimicrobial nanosized metal particles on a filler substrate.

Antimicrobial Metal

The term antimicrobial metal encompasses noble metals such as silver, copper, gold, iridium, palladium, platinum, salts oxides and complexes thereof.

While not wishing to be restricted by theory, it is believed that the silver embedded composite works to effectively kill microbes by exposure of the composite to moisture which in turn causes a slow release of silver ions to bind strongly to electron donor groups on bacterial molecules. The composite is also assumed to exhibit antifungal activity.

Preferably, the antimicrobial metal or antimicrobial metal precursor is silver or copper or complexes or salts thereof, most preferably the antimicrobial metal or antimicrobial metal precursor is silver or complexes or salts thereof.

The antimicrobial metal may exist on the composite in substantially the elemental state (i.e Ag⁰), as a metal complex, oxide or metal salt.

Preferably the antimicrobial metal will exist on the composite as substantially antimicrobial elemental metal, ie. Ag⁰or Cu⁰.

Most preferably the antimicrobial metal on the silica substrate comprises elemental silver (Ag⁰).

Substantially means for purposes of the invention, at least 80 weight percent, preferably 90 weight percent, most preferably 95 weight percent of the deposited antimicrobial metal on the filler is elemental metal wherein the percent is based on the total weight of the antimicrobial metal on the filler.

A precursor of the antimicrobial metal or antimicrobial metal per se is vaporized within the plasma, optionally reduced before cooling and deposited upon the powdered filler substrate or alternative the antimicrobial metal or antimicrobial metal precursor is vaporized along with the filler or filler precursor and then both antimicrobial metal and filler are condensed upon cooling and collected.

Preferably the antimicrobial metal composite comprises an antimicrobial metal, preferably silver, copper, complexes or salts thereof, especially silver, complexes or salts thereof and a filler, preferably silica, silicates, metal oxides (i.e. zinc oxide, titanium dioxide etc.), barium sulfate most preferably silica, silicates, metal oxides and especially zinc oxide, silica and precursors thereof which composite is prepared comprising the steps of:

A) providing an antimicrobial metal or antimicrobial metal precursor;
B) entraining said metal or metal precursor in a stream of gas for transport to a plasma torch;
C) creating a plasma in said stream of gas vaporizing the antimicrobial metal or antimicrobial metal precursor;
D) cooling said antimicrobial metal vapor in the presence of a fluidized gas carrying a filler powder, wherein said cooling results in nucleation of the antimicrobial metal vapor onto the filler to form the composite
wherein the filler in steps D) is
preferably silica, silicates, metal oxides or barium sulfate, most preferably silica, silicates or metal oxides and especially silica and zinc oxide;
and
F) collecting the composite.

The above process wherein the antimicrobial metal or antimicrobial metal precursor vapor, preferably silver or copper, complexes or salts thereof, especially silver, complexes or salts thereof is cooled in the presence of a fluidized gas carrying the filler powder, preferably silica, silicates, metal oxides, barium sulfate, most preferably silica, silicates and metal oxides and especially silica, and the cooling results in nucleation of the antimicrobial metal vapor, especially the metal vapor in the elemental state (i.e. Ag⁰) onto the filler to form the composite is a preferred process.

Examples of precursor silver compounds include but are not limited to silver nitrate, silver sulfate, silver fluoride, silver acetate, silver nitrite, silver bromate, silver salicylate, silver iodate, silver carbonate, silver citrate, silver phosphate, silver chloride, silver bromide, silver iodide, silver cyanide, silver, silver sulfite, stearate, silver benzoate, and silver oxalate.

Examples of precursor copper compounds include Copper (I) acetylide, copper(I) bromide, copper (I) chloride, copper(I) cyanide, copper(I)fluoride, copper(I) phosphide, copper(I0 sulfide, copper (II) acetate, copper (II) oxide, copper(II bromide, copper(II) carbonate, copper (II) chloride, copper(II) fluoride, copper (II) hydroxide, copper (II) nitrate, copper (II) sulfate, copper (II) triflate, cuprates and copper.

While the present composite must contain at least one antimicrobial metal such as silver, copper, gold, iridium, palladium, platinum, salts, oxides and complexes thereof, the composite may also contain additional metals such as zinc, titanium and aluminum, salts, complexes or oxides thereof. The antimicrobial metal may of course contain blends of antimicrobial metals such as silver and copper combined.

### Thermal Plasma Reaction to Produce the Composite

Thermal plasma reactors are known and disclosed for instance in U.S. Pat. No. 5,200,595. The present invention employs an RF induction plasma torch. Induction plasma torches are available for instance from Tekna Plasma Systems Inc., Sherbrooke Quebec.

Thermal plasma torches other than RF may be employed such as DC are plasma torches or microwave discharge plasma. However, RF induction plasma torches are preferred in preparing the antimicrobial metal composite of the invention.

The induction plasma torch is equipped with a powder feeder that operates by entraining the particles in an upward or downward, stream of gas for transport to the plasma induction torch (central gas) where the powder is vaporized. It is possible to inject the particles as a slurry (e.g. aqueous, organic solvents, such as C₁₋₄ alcohols, ketones and di-C₁₋₂ alkyl ethers) into the plasma reactor. The slurry is atomized at the tip of the injection probe.

Preferably the present composite is formed from a powder as this avoids unnecessary contamination of solvents and the like.

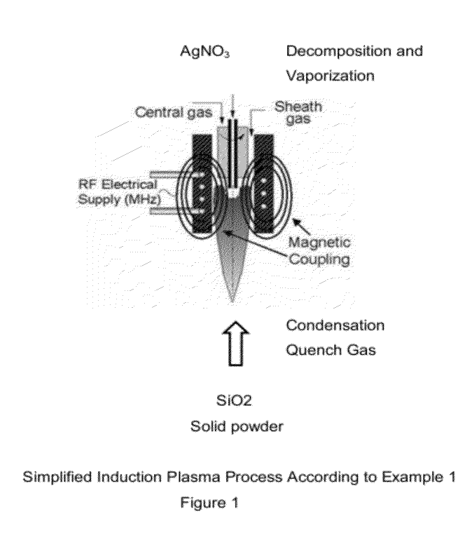

The central gas or alternatively called the gas for transport to the plasma torch carries the powder into the vaporization chamber (see FIG. 1), may be chosen from virtually any gas. However, preferably the central gas is argon, nitrogen, helium, oxygen, hydrogen or mixtures thereof. Most preferably the central gas is argon, nitrogen or helium and especially argon.

Around the central gas is a sheath gas (see FIG. 1) which may contain the same gas or a different gas than in the central gas transporting the powder to the vaporization chamber.

For example, the sheath gas may comprise a mixture of argon or helium with hydrogen. Preferable, the sheath gas comprises argon, helium or nitrogen with a reducing gas such as hydrogen. In forming the present composite is it especially preferable that the central gas comprises argon and the sheath gas comprises a mixture of argon and hydrogen. In this way the preferred silver precursor, silver nitrate, is vaporized and reduced before entering a quench module at the exit of the plasma torch where cooling and nucleation of the metal occurs.

The temperature in the plasma ranges from 5000 to 10000° C., preferably 7000 to 10000° C. The residence time within the plasma ranges from 1 to 100 milliseconds.

The high quench or cooling rate provided by the quench module (cooling) at the exit of the plasma torch is responsible for homogeneous nucleation in the gas phase leading to the formation of ultrafine powders.

A range of unique powder or particulate materials have been previously disclosed using induction plasma. For example, unique effect pigments are disclosed in PCT Publication No. WO2006/131472. Tungstate particles for increasing the heat input amount of near infrared radiation are discussed in US Application Publication No. US20100310787. These tungstate particles are useful in laser marking of polymeric substrates. PCT Publication No. WO2009/106507 discloses expanded graphite nanoplatelets formed in a plasma reactor. None disclose antimicrobial metal composites.

### Antimicrobial Metal Composite

The antimicrobial metal composite comprises antimicrobial metal nanoparticles, preferably silver or copper, ranging from 1 to 20 nm dispersed onto a filler, preferably silica, metal oxides, wherein the nanoparticles are surface accessible on and within the filler matrix; and the antimicrobial metal ranges from 20 to 75 wt. percent, preferably 25 to 75 wt., most preferably 30 to 75 wt. % percent of the composite.

Preferably the nanoparticles are silver and the filler is silica or zinc oxide. The advantage of such a highly loaded (25 to 75 wt. percent) composite, is less filler is required within the substrate in order to achieve the needed antimicrobial effect. As a result, the filler, as less is added, is less likely to impact the mechanical properties of the substrate especially polymeric substrates but is capable of delivering an effective antimicrobial effect.

The antimicrobial metal will exist on the filler in the form of nanoparticles supported by the filler. The antimicrobial metal nanoparticulates are distributed homogeneously on the filler. Thus the nanoparticulates supported throughout the filler may therefore be considered as being in a pre-dispersed state and so dispersing the larger composite (for example such as silica or zinc oxide with nanoparticles dispersed thereon) within polymers or liquids maintains the nanoparticles in a disperse state, thus avoiding agglomeration of the nanoparticles. And because the filler is highly loaded with the antimicrobial metal the composite not only functions as a convenient scaffold for enabling effective dispersion of the nanoparticles in many different substrates but requires less total weight of the composite and therefore is less likely to impact the mechanical properties of the substrate.

The antimicrobial metal composite contains 10 to 80 weight %, preferably 15 to 75 weight %, most preferably 20 to 70 weight % antimicrobial metal, especially 25 to 65 wt. %, wherein the weight % is based on the total weight of the composite.

The antimicrobial metal composite formed from ZnO and silver will preferably contain about 20 to about 75 wt. %, more preferably about 25 to about 65 wt. % silver.

The antimicrobial metal composite formed from silica and silver will preferably contain about 20 to about 75 wt. %, more preferably about 25 to about 65 wt. % and most preferably about 30 to about 65 wt. % silver.

The surface area of the composite is measure by BET. The formed composite will normally have a lower surface area once the antimicrobial metal is deposited onto the surface of the filler. Thus the final composite surface will vary depending upon the filler starting properties. For example, silica having a starting surface area of 200/m²/g once the composite is formed with a loading of about 65 wt. % silver will have a surface area by BET of about 50 m²/g while a composite having a loading of about 40 weight % will have a surface area of about 130 m²/g.

Thus the final composite material, wherein the filler is silica and the antimicrobial metal is silver has a surface area ranging widely depending on the starting surface area of the silica and the metal loading. Accordingly, the surface area of a silica/silver composite will range from 10 to 500 m²/g, preferably 20 to 400 m²/g, most preferably, from 40 to 300 m²/g and especially 40 to 200 m2/g.

It is also possible to combine the antimicrobial metal or antimicrobial metal precursor with other materials such zinc, titanium, copper, aluminum, salts, complexes or oxides. For example, the antimicrobial metal or antimicrobial metal precursor may be combined with titanium isopropoxide, aluminum acetylacetonate, zinc actylacetonate, zinc carbonate or oxides of titanium, aluminum or zinc and transported via transport gas to the plasma chamber along with antimicrobial metal or antimicrobial metal precursor.

For example, AgNO₃ and zinc carbonate or zinc acetylacetonate might be combined in powder or slurry form and transported to the plasma chamber where the mixed powder is vaporized and then cooled in the presence of a inert carrier such as fumed silica. This would result in a silver/zinc oxide silica composite.

Substrates Incorporating or Treated with the Antimicrobial Metal Composite

The formed antimicrobial metal composite may be used to impart antimicrobial and antifungal properties to various substrates. For example, the composite material may be incorporated directly into coatings, textiles, polymers, adhesives, gels, lubricants, paper, pharmaceuticals and cosmetics substrates to provide antimicrobial and antifungal properties to various final goods. Alternatively the composite material of the invention may be used to surface treat coatings, textiles, polymers or paper substrates. For example, the antimicrobial composite may be used as a textile finish or a top coating on surfaces that require long term antimicrobial protection.

The composite material may be incorporated into or onto coatings, textiles, polymers, paper, gels, lubricants, adhesives, pharmaceuticals and cosmetics substrates in amounts ranging from 0.01 to 20 wt. %, preferably 0.1 to 10 wt. % and most preferably 0.5 to 5 wt. % of the antimicrobial composite based on the total weight of the substrate.

Textiles would include among others, a protective article worn by patients, healthcare workers, or other persons who may come in contact with potentially infectious agents or microbes, including an article of clothing such as a gown, robe, face mask, head cover, shoe cover, or glove; alternatively, the protective article may include a surgical drape, surgical fenestration or cover, drape, sheets, bedclothes or linens, padding, gauze dressing, wipe, wet wipes, sponge and other antimicrobial articles for household, institutional, health care and industrial applications. In certain embodiments, the article contains the composite only one surface, for example the surface of a face mask which will face away from the body and possibly be exposed to pathogens. Non-woven substrates are in particular envisioned.

The composite may also be added to such substrates as gels which may be used in combination with the above textile. Additionally the antimicrobial composite may be used directly in gels which are used in wound healing compositions.

The non-woven substrate material is normally a multi layered material. For example, an outer or inner fabric may be layered to another sheet ply, e.g., a filter or barrier media. In many embodiments, not all of the other layers need to be treated with the antimicrobial composite. In one particular embodiment, only one layer of a layered polyolefin fabric is treated with the antimicrobial composite. For example, a SMS polypropylene fabrics which comprise a spunbond polypropylene layer on each face of a melt-bound polypropylene layer are common in protective garments such as face masks and other disposable garments used in hospital settings. Often, only the surface of the fabric that faces away from the body, and exposed to contamination, is treated with an antimicrobial composite. One embodiment of the invention relates to the treatment of only the “outer layer” of such materials and articles.

It is further possible to incorporate the antimicrobial composite into the fibers themselves of the non-woven.

It is further possible to prepare polymer concentrates or masterbatches of the antimicrobial composites. This is possible by combining the powder with a suitable polymer under melt conditions in a heatable container such as a kneader, mixer or extruder. The loading of the composite in the concentrate is for example about 10 to 60 weight percent of the total composition. The masterbatch or polymer concentrate can then easily be incorporated into plastic injection molded articles and synthetic fibers.

The composite of the invention may be incorporated into polymer substrates before crosslinking as the present composite does not interfere with this hardening step. Thus the composite of the invention is effective in a wider range of polymeric substrates than those previously disclosed.

The composite is especially suitable for polysiloxane compositions which further contain optionally a crosslinking agent and a catalyst, especially platinum catalysts. The composite may be added prior to hardening of the composition without interfering with the crosslinking reaction.

The platinum catalysts used for crosslinking of polysiloxanes are well known in the art and are for example hydrosilation catalysts can be, but are not restricted to, platinum divinyltetramethyldisiloxane complex, tris(triphenylphosphine)rhodium I chloride, platinum carbonyl cyclomethylvinyl siloxane complex, platinum octanaldehyde/octanol complex and platinum cyclovinylmethylsiloxane catalyst.

In certain situations, it may be possible to incorporate the “dry” composite into the suitable substrate. This is normally carried out by some form of melt blending such as extrusion and the like.

The polymer substrates of the present invention are for instance:

1. Polymers of monoolefins and diolefins, for example polypropylene, polyisobutylene, po-lybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE). Polyolefins, i.e. the polymers of monoolefins exemplified in the preceding paragraph, preferably polyethylene and polypropylene, can be prepared by different, and especially by the following, methods:

radical polymerization (normally under high pressure and at elevated temperature).
b) catalytic polymerization using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either [pi]- or [sigma]-coordinated. These metal complexes may be in the free form or fixed on substrates, typically on activated magnesium chloride, titanium(III) chloride, alumina or silicon oxide. These catalysts may be soluble or insoluble in the polymerization medium. The catalysts can be used by themselves in the polymerization or further activators may be used, typically metal alkyls, metal hydrides, metal alkyl halides, metal alkyl oxides or metal alkyloxanes, said metals being elements of groups Ia, Na and/or IIia of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is gene-rated in-situ; propylene/butadiene copolymers, isobutylene/isoprene copolymers, ethylene/vi-nylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethyl-lene-propylene copolymers, LDPE/ethylene-vinyl acetate copolymers (EVA), LDPE/ethylene-acrylic acid copolymers (EAA), LLDPE/EVA, LLDPE/EAA and alternating or random polyal-kylene/carbon monoxide copolymers and mixtures thereof with other polymers, for example polyamides.

4. Hydrocarbon resins (for example C5-Cg) including hydrogenated modifications thereof (e.g. tackifiers) and mixtures of polyalkylenes and starch.

Homopolymers and copolymers from 1.)-4.) may have any stereostructure including syndio-tactic, isotactic, hemi-isotactic or atactic; where atactic polymers are preferred. Stereoblock polymers are also included.

5. Polystyrene, poly(p-methylstyrene), poly([alpha]-methylstyrene).

6. Aromatic homopolymers and copolymers derived from vinyl aromatic monomers including styrene, [alpha]-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/bu-tadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/pro-pylene/diene terpolymer; and block copolymers of styrene such as styrene/butadiene/sty-rene, styrene/isoprene/styrene, styrene/ethylene/butylene/styrene or styrene/ethylene/propy-lene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.). Homopolymers and copolymers may have any stereostructure including syndiotactic, isotac-tic, hemi-isotactic or atactic; where atactic polymers are preferred. Stereoblock polymers are also included.

7. Graft copolymers of vinyl aromatic monomers such as styrene or [alpha]-methylstyrene, for example styrene on polybutadiene, styrene on polybutadiene-styrene or polybutadiene-acry-lonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfo-chlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from [alpha],[beta]-unsaturated acids and derivatives thereof such as polyacry-lates and polymethacrylates; polymethyl methacrylates, polyacrylamides and polyacryloni-triles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or ace-tals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadi-enes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an ela-stomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones, for example polyethylene terephthalate, polybutylene tereph-thalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acry-lates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Poly-amide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

Preferred polymer substrates are silicone, silicone rubber, polyurethane, polystyrene, block polyether polyamide (PEBAX®), polyolefin, polysulfone or mixtures thereof.

Polymers are frequently incorporated into coatings as a binder. The composite is especially suitable for incorporation into coatings as opposed to nanoparticulate silver per se. As explained above, the nanosilver particulates embedded on the carrier are more easily dispersed in liquid and polymer systems. The antimicrobial composite containing coating when applied to a surface acts to protect the coated surface from microbial and fungal attack.

Cosmetics formulations may be preserved by incorporation of the disclosed composite.

The disclosed composite may be added to lubricants to impart antimicrobial activity. Lubricants such as silicone lubricants used for inserting catheters and the like come to mind.

Preferably the composite is incorporated into a polymer, plastic, textile, coating or lubricant.

Most preferably the polymer, plastic or coating forms at least a part of a medical device. If a lubricant, the lubricant is preferably a silicone lubricant.

A medical device is for example implantable or insertable medical devices, for example: catheters (e.g., urological or vascular catheters such as balloon catheters and various central venous catheters), guide wires, balloons, filters (e.g., vena cava filters and mesh filters for distil protection devices), stents (including coronary vascular stents, peripheral vascular stents, cerebral, urethral, ureteral, biliary, tracheal, gastrointestinal and esophageal stents), stent coverings, stent grafts, vascular grafts, abdominal aortic aneurysm (AAA) devices (e.g., AAA stents, AAA grafts), vascular access ports, dialysis ports, embolization devices including cerebral aneurysm filler coils (including Guglilmi detachable coils and metal coils), embolic agents, hermetic sealants, septal defect closure devices, myocardial plugs, patches, pacemakers, lead coatings including coatings for pacemaker leads, defibrillation leads, and coils, ventricular assist devices including left ventricular assist hearts and pumps, total artificial hearts, shunts, valves including heart valves and vascular valves, anastomosis clips and rings, cochlear implants, tissue bulking devices, and tissue engineering scaffolds for cartilage, bone, skin and other in vivo tissue regeneration, sutures, suture anchors, tissue staples and ligating clips at surgical sites, cannulae, metal wire ligatures, urethral slings, hernia “meshes”, artificial ligaments, orthopedic prosthesis such as bone grafts, bone plates, joint prostheses, orthopedic fixation devices such as interference screws in the ankle, knee, and hand areas, tacks for ligament attachment and meniscal repair, rods and pins for fracture fixation, screws and plates for craniomaxillofacial repair, dental implants, or other device that is implanted or inserted into the body.

In addition to the antimicrobial composite of the invention, other antimicrobial agents may also be combined with the composite in or on polymers, coatings, textiles, polymers, lubricant, gel, adhesive, paper, pharmaceuticals and cosmetics substrates. For example, a biguanide such as poly-hexamethylene biguanide hydrochloride, a chlorohexine, an alexidine, and relevant salts thereof, stabilized oxidants including stabilized peroxides, sulfides, sulfites such as sodium metabisulfite, polyphenols, bis-phenols including triclosan and hexachlorophene etc, other quaternary ammonium compounds including quaternary ammonium siloxanes, cetyl pyridinium chloride, quaternized cellulose and other quaternized polymers; additional antimicrobial metals and metal-containing compounds such as silver containing antimicrobials (HyGentic® 8000), a halogen-releasing agent or halogen-containing polymer, a thiazole, a thiocynate, an isothiazolin, a cyanobutane, a dithiocarbamate, a thione, a triclosan, an alkylsulfosuccinate, various “naturally occurring” agents for example polyphenols from green or black tea extract, citric acid, chitosan, anatase TiO₂, tourmaline, bamboo extract, neem oil etc, hydrotropes (strong emulsifiers) and chaotropic agents (alkyl polyglycosides) and synergistic combinations thereof.

### EXAMPLES

### Synthesis of Antimicrobial Metal Composite

### Example 1

### Silver-Silica Composite

Silver nitrate powder (AgNO₃) powder is used as the silver source. The as-received powder is milled, sieved and dried in an atmospheric oven at 110° C. before being transferred in a powder feeder to a PFV 100 Tekna Plasma Systems Inc. The powder is injected axially into the reactor through a water cooled dispersion probe SU 1270-260A2 with the tip positioned 20 mm below torch coil center. AgNO₃ powder feed rate is ˜55 g/min while carrier gas flow is set to 14 L/min of argon. The AgNO₃ powder is vaporized in the high energy plasma operated at 55 kW at reactor pressure of 400 Torr where temperature at the center of the discharge may reach ˜10 000° C. Silica (HDK® N20, Wacker Chemie AG, Germany) is mixed with argon by means of a fluidized bed before being carried by the fluidizing gas (˜20 L/min) up to the quench module where it is evenly distributed into the quenching zone thanks to a secondary argon quench flow of 60 L/min. The silica powder is fed at a rate of ˜30 g/min. Silver nanoparticles are produced upon contact with the argon quench gas containing the silica nanoparticles. The silver nanoparticles nucleate onto the silica particles giving a composite wherein the majority of the silver nanoparticles range from 1-20 nm.

The silver loading for the composite may vary from 20 to 75 wt. % based on the weight of the total composite.

Silver/silica composites are made with varying amounts of silver as a weight % of the composite. These are tested in various polymeric substrates below.

TABLE 1
Silver as a weight % of the Silica Composite.

| Silver | Wt % |
|---|---|
| 08-AgSi-01-08 | 43.5 |
| 10-AgSi-0116 | 60 |
| 10-AgSi-1718 | 70.1 |
| 10-AgSi-16FB | 33.9 |
| 09-AgSi-344FB | 65.1 |
| 09-AgSi-4447 | 43.5 |

### Example 2

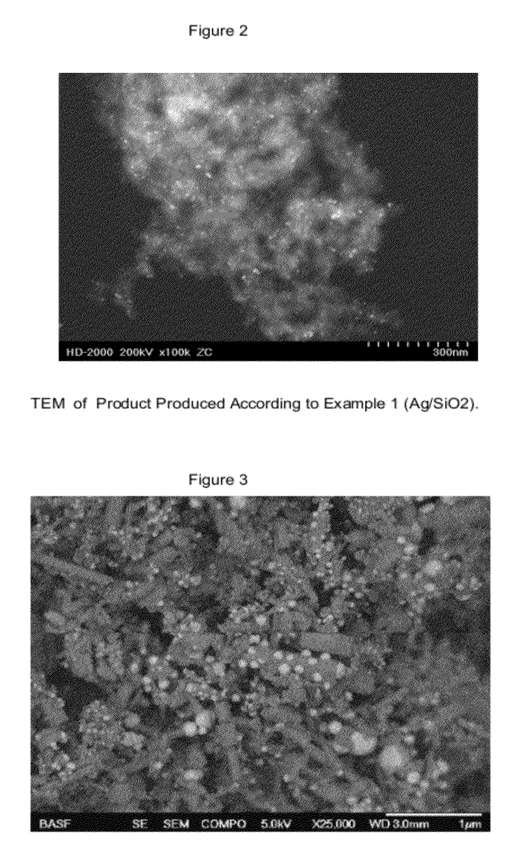

Zinc carbonate and Silver nitrate (25 wt. % silver) are injected into the plasma as powder as above but at a feed rate of about 9 g/min. The powder is injected axially into the reactor through a water cooled dispersion probe SU 1270-260A2 with the tip positioned 20 mm below torch coil center. The carrier gas is argon. The sheath gas is argon. Oxygen is supplied in the sheath gas at 50 slpm. The AgNO₃ powder and zinc carbonate are vaporized in the high energy plasma operated at 55 kW at reactor pressure of 400 Torr where temperature at the center of the discharge may reach ˜10 000° C. Upon entering the quench zone the silver and zinc oxide nucleate forming submicron particles giving a composite wherein the majority of the silver nanoparticles range from 1-20 nm. The silver loading onto the zinc oxide ranges from 20 to 40 wt. percent. See FIG. 2b) for the TEM of the formed composite done in COMPO mode to contrast the silver nanoparticles on the ZnO. XRD Revealed approximated rod-shaped ZnO and a crystal phase of Wurtzite.

TABLE 1a
Silver as a weight % of ZnO

| | Wt % | |
|---|---|---|
| Silver | Ag | Wt. % Zn |
| 10-51620-Zn-01FB | 0 | 80.3 |
| 10-516200-Zn-04FB | 25 | 60.2 |
| 10-516200-Zn-05FB | 35 | 52.1 |
| 10-516200-Zn-06FB | 45 | |

### Application Examples

### Preparation of Liquid Silicone Rubber (LSR) Samples

### Example 3

The liquid silicone rubber is a two component system supplied by NuSil® (www.NuSil.com). Part A contains the polydimethylsiloxane polymer and a platinum catalyst while part B contains the cross-linking agent.

Part A of MED-4850 (44.5 g) is added to a 100 gram SpeedMixer cup. CSM-4850-9 (4 g) is added and the resulting material is placed in a SpeedMixer for 10 seconds at 3300 rpm. The cup is removed and Part B of MED-4850 (48.5 g) is added. The cup is mixed for another 10 seconds at 3300 rpm. 09-AgSi-4447 (3 g, 3% by wt.) is added directly on top of the silicone material and the cup is mixed for 1 minute at 2500 rpm. The cup is removed and the formulation is manually stirred with a wooden applicator stick to help disperse the silver powder. The cup is placed back into the SpeedMixer for an additional minute at 3300 rpm.

The silicone formulation is to be compression molded into 4×4 inch plaques using a Wabash Compression Molder. The chosen mold is 4×4 inch with a 40 mil thickness. The metal platen consisted of two plates which are used to compress the silicone into the mold. A sheet of aluminum is placed on the first metal plate followed by a sheet of milar. The 4×4×40 mil mold is placed on top of the milar and 13 grams of the silicone formulation is added to each of the four slots. A sheet of milar is placed directly on top followed by a sheet of aluminum. The second metal plate is placed on top and the resulting platen is placed into the compression molder. The material is cured at 150° C. (302° F.) for five minutes at a pressure of 28 tons. After five minutes, the platen is moved to the cooling chamber and again compressed for five minutes at a pressure of 28 tons. The platen is removed after five minutes and the silicone plaques are manually removed from the mold.

Antimicrobial testing is performed using either the ASTM E 2149 test method on extruded polymer strands or the JIS Z 2801 test method on the 5 cm×5 cm (2″×2″) plaques. Samples are tested with E. coli and/or S. aureus as representative Gram negative and Gram positive microbes.

TABLE 2
Efficacy of Silver Composite in Liquid Silicone Rubber-Incubation for 24 hours, JIS Z
2801 protocol.
HyGentic ® 8000 is a Zeolite incorporating Silver 3.5 wt. % and 6.5 wt. % Zinc ions.

| | | Colony | | | |
|---|---|---|---|---|---|
| | | Forming Units | | Log Reduction | |
| Resin | Formulation | E. coli | S. aureus | E. coli | S. aureus |
| ¹MED4850 Liquid | Blank | 3.0 × 10⁶ | 2.1 × 10⁵ | | |
| Silicone Rubber | | | | | |
| | 1.0% 09-AgSi-4447 | <10 | 1.3 × 10² | 5.5 | 3.2 |
| | 2.0% 09-AgSi-4447 | <10 | <10 | 5.5 | 4.3 |
| | 3.0% 09-AgSi-4447 | <10 | <10 | 5.5 | 4.3 |
| | 1.0% 09-AgSi- | <10 | <10 | 5.5 | 4.3 |
| | 447 + 1.0% Hygentic ® | | | | |
| | 8000 | | | | |
| | 2.0% 09-AgSi- | 13 | 2.7 × 10² | 5.3 | 2.9 |
| | 447 + 1.0% HyGentic ® | | | | |
| | 8000 | | | | |
| | 2.0% 09-AgSi- | <10 | <10 | 5.5 | 4.3 |
| | 447 + 2.0% HyGentic ® | | | | |
| | 8000 | | | | |
| MED4850 Liquid | Blank | 4.1 × 10⁵ | 9.9 × 10⁴ | | |
| Silicone Rubber | | | | | |
| | 3.0% HyGentic ® 8000 | 4.4 × 10² | 3.8 × 10² | 3.2 | 2.5 |
| | 5.0% HyGentic ® 8000 | <10 | <10 | 4.6 | 4 |
| | 3.0% 09-AgSi-4447 | <10 | <10 | 4.6 | 4 |
| | 5.0% 09-AgSi-4447 | <10 | <10 | 4.6 | 4 |
| | 3.0% 09-AgSi-3443FB | 39 | 2.8 × 10² | 4.2 | 3.2 |
| | 5.0% 09-AgSi-3443FB | <10 | <10 | 4.6 | 4 |
| MED4850 Liquid | Blank | 3.1 × 10⁶ | 7.9 × 10⁵ | | |
| Silicone Rubber | | | | | |
| | 1.0% 10-AgSi-0116 | 5 × 10⁵ | 2.1 × 10³ | 1.9 | 2.6 |
| | 2.0% 10-AgSi-0116 | <10 | 13 | 5.6 | 4.7 |
| | 1.0% 10-AgSi-16FB | <10 | 1.6 × 10² | 5.6 | 4 |
| | 2.0% 10-AgSi-16FB | <10 | 1.6 × 10² | 5.6 | 3.7 |
| | 1.0% 10-AgSi-1718 | <10 | 1.7 × 10³ | 5.6 | 2.8 |
| | 2.0% 10-AgSi-1718 | <10 | 1.8 × 10² | 5.6 | 3.7 |

### Preparation of High Consistency Rubber Samples

### Example 4

The high consistency rubber is a two component system supplied by NuSil® (www.NuSil.com). Part A contains the polydimethylsiloxane polymer and a platinum catalyst while part B contains the cross-linking agent.

Part A (27.3 g) and Part B (29.1 g) of MED-4750 is added to a 2 rool-mil Brabender set at 60 rpm. CAT-55 (1.8 g) is added and the resulting formulation is mixed for 1 minute. The 09-AgSi-4447 (1.8 g, 3% by wt.) is slowly added to the Brabender with continuous mixing. The resulting formulation is mixed for an additional 2 minutes after all of the silver powder is added. The Brabender is shut off and the silicone rubber is manually removed from the mixing chamber.

The silicone formulation is compression molded into 4×4 inch plaques using a Wabash Compression Molder. The chosen mold is 4×4 inch with a 40 mil thickness. The metal platen consists of two plates which are used to compress the silicone into the mold. A sheet of aluminum is placed on the first metal plate followed by a sheet of milar. The 4×4×40 mil mold is placed on top of the milar and 13 grams of the silicone formulation is added to each of the four slots. A sheet of milar is placed directly on top followed by a sheet of aluminum. The second metal plate is placed on top and the resulting platen is placed into the compression molder. The material is cured at 116° C. (240° F.) for ten minutes at a pressure of 28 tons. After ten minutes, the platen is moved to the cooling chamber and again compressed for ten minutes at a pressure of 28 tons. The platen is removed after ten minutes and the silicone plaques are removed from the mold.

TABLE 3
Efficacy of Silver Silica Composite in High Consistency Silicone Rubber, incubated for
24 hours using JIS Z 2801 protocol.

| | | Colony | | | |
|---|---|---|---|---|---|
| | | Forming Units | | Log Reduction | |
| Resin | Formulation | E. coli | S. aureus | E. coli | S. aureus |
| MED4750 High | Blank | 4.2 × 10⁶ | 1.4 × 10⁶ | | |
| Consistency Rubber | 1.0% 09-AgSi-4447 | 13 | 1.3 × 10² | 5.4 | 4.1 |
| | 2.0% 09-AgSi-4447 | <10 | 70 | 5.6 | 4.6 |
| | 3.0% 09-AgSi-4447 | <10 | <10 | 5.6 | 5.1 |
| | 1.0% 09-AgSi-4447 + 1.0% | <10 | 52 | 5.6 | 4.5 |
| | Hygentic ® 8000 | | | | |
| | 2.0% 09-AgSi-4447 + 1.0% | <10 | 1.1 × 10² | 5.6 | 4.1 |
| | HyGentic ® 8000 | | | | |
| | 2.0% 09-AgSi-4447 + 2.0% | 13 | 80 | 5.4 | 4.3 |
| | HyGentic ® 8000 | | | | |
| MED4750 High | Blank | 1.1 × 10⁶ | 5.8 × 10⁵ | | |
| Consistency Rubber | 3.0% 09-AgSi-4447 | 1.6 × 10² | 4.3 × 10² | 4 | 3.3 |
| | 5.0% 09-AgSi-4447 | 45 | 50 | 4.5 | 4.3 |
| | 3.0% 09-AgSi-3443FB | 64 | 1.6 × 10³ | 4.2 | 2.6 |
| | 5.0% 09-AgSi-3443FB | 2.5 × 10² | 4.2 × 10² | 3.7 | 3.5 |
| MED4750 High | Blank | 2.7 × 10⁶ | 1.1 × 10⁶ | | |
| Consistency Rubber | 1.0% 10-AgSi-0116 | 2.6 × 10² | 3.1 × 10⁵ | 4.6 | 1.2 |
| | 2.0% 10-AgSi-0116 | 1.1 × 10⁴ | 4.9 × 10³ | 3.8 | 2.6 |
| | 1.0% 10-AgSi-16FB | 9 × 10⁴ | 1.3 × 10⁵ | 2.4 | <1 |
| | 2.0% 10-AgSi-16FB | <10 | 6.6 × 10³ | 5.4 | 2.2 |
| | 1.0% 10-AgSi-1718 | 26 | 2 × 10³ | 5.1 | 2.7 |
| | 2.0% 10-AgSi-1718 | 6.8 | 6.7 × 10² | 5.4 | 3.2 |

HyGentic ® 8000 is a Zeolite incorporating Silver (3-4 Wt. %) and Zinc ions.

### Example 5

Tables 4a and 4b—Comparison of Efficacy of Silver Silica Composite (example 1) and Silver Zinc Composite (example 2) in Liquid Silicone Rubber and High Consistency Silicone Rubber (supplied by NuSil®) in S. aureus and in E. coli. Composite 10-1516200-Zn-06FB is 45 wt. % silver based on the total weight of the composite. All samples incubated for 24 hours using JIS Z 2801 protocol.

S. aureus ATCC# 6738

| | | | | | | Log |
|---|---|---|---|---|---|---|
| Sample Name | | CFU/mL Sample | | | | Reduction |
| Liquid | Blank | 6.41E+04 | 7.97E+04 | 4.09E+05 | 3.22E+05 | N/A |
| Silicone | 3% 09-AgSi-4447 | <10 | <10 | 4.00E+01 | 1.00E+01 | 4.56 |
| Rubber | 1% 09-AgSi-4447 | 1.00E+01 | 3.00E+01 | 5.00E+01 | 2.00E+01 | 3.84 |
| | 2.9% 10-516200-Zn-06FB | 1.00E+01 | 1.00E+01 | 7.50E+02 | 6.50E+02 | 3.29 |
| | 0.97% 10-516200-Zn-06FB | 8.70E+02 | 7.60E+02 | 4.00E+01 | 3.00E+01 | 2.99 |
| High | Blank | 1.36E+05 | 1.45E+05 | 5.28E+04 | 4.94E+04 | N/A |
| Consistency | 3% 09-AgSi-4447 | <10 | 2.00E+01 | 2.00E+01 | 1.00E+01 | 4.31 |
| Rubber | 1% 09-AgSi-4447 | 1.00E+02 | <10 | 2.00E+02 | 2.20E+02 | 3.81 |
| | 2.9% 10-516200-Zn-06FB | <10 | <10 | 9.00E+01 | 1.00E+02 | 3.79 |
| | 0.97% 10-516200-Zn-06FB | 8.80E+02 | 7.50E+02 | 7.00E+01 | 9.00E+01 | 4.34 |

E. coli ATCC# 8739

| | | | | | | Log |
|---|---|---|---|---|---|---|
| Sample Name | | CFU/mL Sample | | | | Reduction |
| Liquid | Blank | 3.15E+04 | 2.32E+04 | 6.64E+03 | 9.44E+03 | N/A |
| Silicone | 3% 09-AgSi-4447 | <10 | <10 | <10 | <10 | >3.17 |
| Rubber | 1% 09-AgSi-4447 | <10 | <10 | <10 | <10 | >3.17 |
| | 2.9% 10-516200-Zn-06FB | <10 | <10 | <10 | <10 | >3.17 |
| | 0.97% 10-516200-Zn-06FB | <10 | <10 | <10 | <10 | >3.17 |
| High | Blank | 1.61E+04 | 1.85E+04 | 1.92E+04 | 2.00E+04 | N/A |
| Consistency | 3% 09-AgSi-4447 | <10 | <10 | <10 | <10 | >3.26 |
| Rubber | 1% 09-AgSi-4447 | <10 | <10 | <10 | <10 | >3.26 |
| | 2.9% 10-516200-Zn-06FB | <10 | <10 | <10 | <10 | >3.26 |
| | 0.97% 10-516200-Zn-06FB | <10 | <10 | <10 | <10 | >3.26 |

### Comparative Example

### Example 6

### Silver-Silica Composite vs. HeiQ® AGS-20

A study was carried out to compare the present antimicrobial composite, Ag/Si to a commercially available silver-silica composite (HeiQ® AGS-20, HeiQ materials, Bad Zurzach, Switzerland) material. The HeiQ material has a silver loading of 20 weight % and is made via flame spray pyrolysis.

The formulations containing 09-AgSi-4447 (inventive silver-silica composite) cured in the liquid silicone rubber and high consistency silicone rubber. However, formulations containing the HeiQ AGS-20 material (even at 2% total composite loading) did not cure under similar conditions. This shows a clear advantage for using the inventive Ag/Si material due to ease of curing.

### Examples 7-9

### Blending of Various Polymers with Silver-Silica Composite

A common procedure is followed for preparing various polymer samples incorporating the inventive silver-silica composite. The base resin is ground prior to use to insure good mixing with the composite powders. Each individual antimicrobial composite is Henschel-mixed with the ground resin at a 3% loading level. For moisture-sensitive resins (TPUs, polyamide, and polysulfones) blends are dried overnight, at the recommended temperature, under a vacuum before compounding on an 18 mm Leistritz twin screw extruder. Processing temperatures are selected based on manufacturer's recommendation. The exudates are pelletized except for a short strand collected for testing in the ASTM E 2149 antimicrobial test. After re-drying the compounded pellets, plaques are prepared either by injection molding 2″×2″×60 mils samples or compression molding 4″×4″×10 mils plaques. These plaques are then cut down to 5 cm×5 cm coupons for the JIS Z 2801 test.

TABLE 5
Efficacy of Silver-Silica Composite measured using standard ASTM E 2149.
All composite materials were made according to example 1.

| | | Colony | | | |
|---|---|---|---|---|---|
| | | Forming Units | | Log Reduction | |
| Resin | Formulation | E. coli | S. aureus | E. coli | S. aureus |
| Polysulfone/ | Blank | 3.9 × 10⁵ | 2.9 × 10⁵ | | |
| Ultrason ® P 3010 | 3.0% 10-AgSi-0116 | 9 | 1.5 × 10² | 5.0 | 3.4 |
| Polyethylene/ | Blank | 5.4 × 10⁵ | | | |
| Proprietary | | | | | |
| Customer Blend | 3.0% 10-AgSi-0116 | 3.0 × 10² | | 3.8 | |
| Thermoplastic | Blank | 2.0 × 10⁵ | 1.9 × 10⁵ | | |
| Polyurethane/ | 3.0% 09-AgSi-3443CB | 10 | 40 | 4.3 | 3.9 |
| Elastollan ® 1190A | | | | | |
| Thermoplastic | Blank | 6.3 × 10⁵ | | | |
| Polyurethane/ | 3.0% 10-AgSi-0116 | 3.3 × 10² | 3.3 | | |
| Isoplast ® 2530 | | | | | |
| Polysulfone/ | Blank | 8.9 × 10⁵ | | | |
| Ultrason ® E 3010 | 3.0% 10-AgSi-0116 | 4.1 × 10² | 3.4 | | |

TABLE 6
Efficacy of Silver-Silica Composite using standard method JIS Z 2801 after 24 hours.
All composites were made according to examples 1 and 2.

| Resin | Formulation | Colony Forming Units | | Log Reduction | |
|---|---|---|---|---|---|
| | | C. albicans | P. aeruginosa | C. albicans | P. aeruginosa |
| Glass Filled | Blank | 5.4E+04 | 2.6E+04 | | |
| Polyamide- | | 3.9E+04 | 1.2E+05 | | |
| 6/Ultramid ® B3EG5 | 10-AgSi-0116 | <10 | <10 | >3.7 | >3.9 |
| | | <10 | <10 | | |
| | 10-516200-Zn-06FB | <10 | <10 | >3.7 | >3.8 |
| | | <10 | <10 | | |
| | | E. coli | S. aureus | E. coli | S. aureus |
| Thermoplastic | Blank | 2.4 × 10⁶ | 5.1 × 10⁵ | | |
| Polyurethane/ | 3.0% 09-AgSi-01-8 | 2.6 × 10³ | 8.1 × 10² | 4.0 | 3.6 |
| Pellethane ® 2363- | | | | | |
| 90A | | | | | |
| Thermoplastic | Blank | 1.3 × 10⁶ | 1.5 × 10⁵ | | |
| Polyurethane/ | 3.0% 09-AgSi-01-8 | 18 | <10 | 4.9 | 4.2 |
| Pellethane ® 2363- | | | | | |
| 90A | | | | | |
| Thermoplastic | Blank | 2.9 × 10⁶ | 7.7 × 10² | | |
| Polyurethane/ | 3.0% 09-AgSi-4447 | <10 | <10 | >5.5 | >1.9 |
| Pellethane ® 2363- | 3.0% 10-AgSi-0116 | <10 | <10 | >5.5 | >1.9 |
| 90A | 3.0% 10-AgSi-16FB | <10 | <10 | >5.5 | >1.9 |
| | 3.0% 10-AgSi-1718 | <10 | <10 | >5.5 | >1.9 |
| Thermoplastic | 30% BaSO₄ | 2.4 × 10⁶ | 2.1 × 10⁵ | | |
| Polyurethane/ | BaSO4 + 3.0% 09-AgSi- | <10 | <10 | >5.4 | >4.3 |
| Pellethane ® 2363- | 3443FB | | | | |
| 90A | | | | | |
| Thermoplastic | Blank | 6.3 × 10³ | 5.4 × 10⁵ | | |
| Polyurethane/ | 3.0% 10-AgSi-0116 | <10 | <10 | >2.8 | >4.7 |
| Carbothane ® PC- | | | | | |
| 3585A | | | | | |
| Thermoplastic | Blank | 1.5 × 10⁶ | | | |
| Polyurethane/ | 3.0% 10-AgSi-0116 | 1.6 × 10³ | 3.6 | | |
| Tecoflex ® EG-85A | | | | | |
| Polyethylene/Proprietary | Blank | 4.5 × 10⁵ | | | |
| customer | 3.0% 10-AgSi-0116 | <10 | >4.7 | | |
| blend | | | | | |
| Thermoplastic | Blank | 1.5 × 10⁶ | 1.1 × 10⁵ | | |
| Polyurethane/ | 3.0% 09-AgSi-01-08 | 1.7 × 10³ | 2.4 × 10³ | 3.0 | |
| Elastollan ® 1190A | 3.0% 09-AgSi-3443FB | 2.5 × 10³ | 6.0 × 10² | 3.0 | |
| | #.0% 09-AgSi-3443CB | 84 | 7.1 × 10³ | 4.3 | |
| | 3.0% 09-AgSi-4447 | 1.4 × 10² | 1.1 × 10³ | 4.5 | |

TABLE 7
Efficacy of Silver-Zinc Oxide (sample JIS Z 2801 made according to
example 2) Composite in Thermoplastic Urethane (TPO) at 1.5 wt.
% Composite.

| | | Colony | | Log Reduction | |
|---|---|---|---|---|---|
| | | Forming Units | | | S. |
| Resin | Formulation | E. coli | S. aureus | E. coli | aureus |
| Thermoplastic | No | 1.8E+05 | 8.4E+05 | | |
| Polyurethane/ | Anti- | 3.9E+04 | 2.2E+05 | | |
| Elastollan ® | microbial | | | | |
| 1190A | ZnO | 26 | 4.0E+04 | 3.3 | 2.1 |
| | | 1.2E+02 | 4.5E+02 | | |
| | 1:4 Ag/ZnO | <10 | <10 | 3.3 | 3.6 |
| | | 2.4E+02 | 1.8E+03 | | |
| | 1:3 Ag/ZnO | <10 | <10 | 4.0 | 4.7 |
| | | <10 | <10 | | |
| | 1:2 Ag/ZnO | <10 | <10 | 4.0 | 4.7 |
| | | <10 | 13 | | |
| | 2:3 Ag/ZnO | <10 | <10 | 3.1 | 4.7 |
| | | 8.6E+02 | <10 | | |

We claim:

1. An antimicrobial metal composite, wherein the composite comprises an antimicrobial metal and a filler which composite is prepared comprising the steps of:
A) providing an antimicrobial metal or antimicrobial metal precursor;
B) entraining said metal or metal precursor in a stream of gas for transport to a plasma torch;
C) creating a plasma in said stream of gas vaporizing the antimicrobial metal or antimicrobial metal precursor;
D) cooling said metal vapor in the presence of a fluidized gas carrying a filler powder, wherein said cooling results in nucleation of the antimicrobial metal vapor onto the filler to form the composite
or
E) alternatively, the filler or a filler precursor is entrained with the antimicrobial metal or antimicrobial metal precursor in step B) vaporized in step C) and upon cooling the antimicrobial metal vapor and filler vapor condense to form the composite;
and
F) collecting the composite.

2. The antimicrobial metal composite according to claim 1, wherein the cooling of said antimicrobial metal vapor occurs in the presence of a fluidized gas carrying a powder filler, wherein said cooling results in nucleation of the metal vapor onto the filler to form the composite.

3. The antimicrobial metal composite according to claim 1, wherein the filler or a filler precursor is entrained with the antimicrobial metal or antimicrobial metal precursor in step B) vaporized in step C) and upon cooling the antimicrobial metal vapor and filler vapor condense to form the composite.

4. The antimicrobial metal composite according to claim 1, wherein the filler or filler precursor is selected from the group consisting of silica, silicates including alkali/aluminum silicates, carbonates such as magnesium or calcium carbonates or dolomite, glass fibres or glass spheres, asbestos, talc, kaolin, mica, metal oxides or metal hydroxides, carbon black, graphite, carbon fibres or wiskers, ceramic fibres or wiskers, zinc borate, alumina trihydrate, calcium silicate or magnesium silicate, wollastonite, barium sulfate, barium titanate, barium ferrite and precursors thereof, preferably silica, silicates, metal oxides, barium sulfate and precursors thereof.

5. The antimicrobial metal composite according to claim 1, wherein the vaporization step C) occurs at temperatures of at least 7000° C.

6. The antimicrobial metal composite according to claim 1, wherein the antimicrobial metal or antimicrobial metal precursor in step B) is a solid powder entrained in the stream of gas.

7. The antimicrobial metal composite according to claim 1, wherein the composite contains greater than about 20 to about 75 weight % silver, preferably about 25 to about 70 weight % silver and most preferably about 25 to about 65 weight % silver.

8. The antimicrobial metal composite according to claim 1, wherein the filler is silica and the composite has a BET surface ranging between 30 m²/g and 160 m²/g.

9. An antimicrobial composite comprising antimicrobial metal nanoparticles ranging from 1 to 20 nm dispersed onto a filler, wherein the antimicrobial metal nanoparticles are surface accessible on and within the filler matrix;
and the antimicrobial metal ranges from 25 to 75 wt. percent of the composite, wherein the antimicrobial nanoparticles are silver and/or copper and the filler is silica, silicates, metal oxides or barium sulfate.

10. A composition comprising a substrate selected from the group consisting of coatings, ink, adhesives, lubricants, textiles, polymers or plastics, paper, pharmaceuticals and cosmetics which substrate further comprises the antimicrobial composite formed according to claim 1.

11. A composition according to claim 10 comprising 0.1 to 20 wt. % of the antimicrobial composite based on the total weight of the substrate.

12. A medical device incorporating the product formed according to claim 1.

13. A composition according to claim 10, wherein the polymer is selected from the group consisting of silicone, silicone rubber, polyurethane, polystyrene, block polyether polyamide (i.e. PEBAX®), polyolefin and polysulfone.

14. A composition according to claim 10, wherein the substrate is a textile, and the textile is in the form of a gauze, bandage, wound dressing, film dressing and adhesive plaster pads, supporters, sheets, wipers, wipes, surgical drape or surgical clothing.

15. A process of forming an antimicrobial silicone rubber composition, comprising the steps of
i.) adding the composite according to the product formed according to claim 1 to a silicone rubber composition which composition comprises
a polysiloxane,
optionally a crosslinker
and a catalyst,
ii.) and curing the composite containing composition of step i.).

16. A process of forming an antimicrobial polymeric material, comprising the steps of incorporating into or treating a polymer with the composite according to the product formed according to claim 1.

17. The composition according to claim 10, wherein the substrate is a textile and the textile is a nonwoven.

18. The composition according to claim 10, wherein the substrate is a polymer and the polymer is at least part of a medical device.

19. A process for the formation of an antimicrobial metal composite, comprising the steps of
A) providing an antimicrobial metal or antimicrobial metal precursor;
B) entraining said antimicrobial metal or antimicrobial metal precursor in a stream of gas for transport to a plasma torch;
C) creating a plasma in said stream of gas vaporizing the antimicrobial metal or antimicrobial metal precursor;
D) cooling said metal vapor in the presence of a fluidized gas carrying a filler powder, wherein said cooling results in nucleation of the antimicrobial metal vapor onto the filler to form the composite
or
E) alternatively, the filler or a filler precursor is entrained with the antimicrobial metal or antimicrobial metal precursor in step B) vaporized in step C) and upon cooling the antimicrobial metal vapor and filler vapor condense to form the composite;
and
F) collecting the composite.
